(19) United States
(12) Patent Application Publication
(10) Pub. No.: US 2012/0174413 A1
(43) Pub. Date: Jul. 12, 2012

(54) Folding utility knives with retractable blade

(76) Inventors: Glenn Robinson, Parkland, FL (US); Min-Zheng Zeng, (US)

(21) Appl. No.: 13/200,852

(22) Filed: Oct. 4, 2011

Related U.S. Application Data
(60) Provisional application No. 61/461,039, filed on Jan. 11, 2011.

(51) Int. Cl. B26B 1/02; B26B 5/00; B26B 1/08

(52) U.S. Cl. 30/154

(57) ABSTRACT

The present invention provides for a folding utility knife comprising: a handle pivotally connected to a blade holding compartment, the handle comprises at least two side walls forming a space, the space of the handle designed to encase at least a portion of a blade holding compartment during a folded position, the blade holding compartment comprising an internal cavity leading to an opening at a front end of the blade holding compartment which allows a portion of a blade to protrude from the blade holding compartment, a rear end of the blade holding compartment is pivotally attached to one end of the handle; and a device that allows the blade to be in a first extended position during use and then be retracted to a second non-use position, the entire blade is situated within the internal cavity of the blade holding compartment during the second position.

### RELATED APPLICATIONS

This application is related to U.S. Provisional Application Ser. No. 61/461,039 filed Jan. 11, 2011 and entitled “Folding Utility Knife with Retractable Blades”.

### BACKGROUND OF THE INVENTION

1. Field of the Invention

This invention relates to a folding utility knife and more specifically, to a utility knife with a disposable and retractable blade and a blade storage cartridge.

2. Description of the Related Art

There are various patents covering folding utility knife type devices.

### SUMMARY OF THE INVENTION

In one embodiment, the present invention provides for a folding utility knife, the knife comprises: a handle comprising an internal space; a blade holding compartment pivotally connected to one end of the handle, and the blade holding compartment has an opening; a disposable blade disposed within at least a portion of the blade holding compartment, at least a portion of the blade protrudes from the opening of the blade holding compartment during a first position; and a mechanism for retracting the blade completely within the blade holding compartment during a second position.

In another embodiment, the blade has at least one side with a sharp edge for cutting, at least a portion of the blade is situated within the blade cavity of the blade holding compartment and a portion of the blade is situated outside of the blade holding compartment to expose at least a portion of the sharp edge of the blade.

In yet another embodiment, knife of further comprises an external device for controlling the mechanism which extends and retracts the blade. In still another embodiment, the mechanism comprises a track device which allows the blade to slideably move within the blade holding compartment.

In still yet another embodiment, at least a portion of the blade holding compartment is to be folded within the space of the handle during a storage position. In a further embodiment, the first position of the blade is in a use position. In yet a further embodiment, the second position of the blade is in a non-use position.

In still a further embodiment, the knife further comprises a storage cartridge with a plurality of disposable blades. In another further embodiment, the cartridge is stored within a portion of the blade storage compartment. In still yet a further embodiment, the cartridge is stored within a portion of the handle.

In another embodiment, the blade holding compartment and the handle must be positioned at an angle of generally 90 degrees or less to allow for access to the storage cartridge.

In yet another embodiment, at least one end of the blade holding compartment is directly and pivotally attached to at least one end of the handle.

In still another embodiment, the present invention provides for a folding utility knife comprising: a handle comprising an internal space; a blade holding compartment pivotally connected to one end of the handle, the blade holding compartment has an opening, and the opening is situated on an opposing end of where the handle is pivotally attached to the blade holding compartment; a disposable blade disposed within at least a portion of the blade holding compartment, at least a portion of the blade protrudes from the opening of the blade holding compartment during a first use position; and a means for retracting and extending the blade between the first use position and a second non-use position.

In still yet another embodiment, the knife further comprises a blade storage cartridge situated within at least a portion of the blade holding compartment. In a further embodiment, the knife further comprises a blade storage cartridge situated within at least a portion of the handle.

In another further embodiment, the present invention relates to a folding utility knife comprising: a handle pivotally connected to a blade holding compartment, the handle comprising at least two side walls forming a space, the space of the handle designed to encase at least a portion of a blade holding compartment during a folded position, the blade holding compartment comprising an internal cavity leading to an opening at a front end of the blade holding compartment which allows a portion of a blade to protrude from the blade holding compartment, a rear end of the blade holding compartment is pivotally attached to one end of the handle; and a device that allows the blade to be in a first extended position during use and then be retracted to a second non-use position, the entire blade is situated within the internal cavity of the blade holding compartment during the second position.

In another embodiment, the rear end of the blade holding compartment comprises an aperture, and the knife further comprising cartridge with a plurality of disposable blades, and the cartridge is stored within the internal cavity of through the rear end of the blade holding compartment.

In yet another embodiment, the handle and blade holding compartment are positioned at a 90 degree or less to allow access to the cartridge. In still another embodiment, the knife further comprises a lock for locking the blade holding compartment during the folded position. In still yet another embodiment, the knife further comprises a mechanism for locking the blade within the blade holding compartment.

In another embodiment, the present invention provides for a folding utility knife with a retractable blade, the knife comprises: a handle comprising an internal space; a blade holding compartment pivotally connected to one end of the handle, the blade holding compartment having an opening, at least a portion of the blade holding compartment is folded and situated within at least a portion of the space of the handle during a storage position, the blade holding compartment is extended away from the handle during an extended usage position; a disposable blade is disposed within at least a portion of the blade holding compartment; a mechanism for extending the blade so that at least a portion of the blade protrudes from the opening of the blade holding compartment during a first position and retracting the blade completely within the blade holding compartment during a second position; and a safety mechanism that prevent the blade from being extended until the blade holding compartment is fully extended during said usage position.

In a further embodiment, the present invention provides for a knife with an extendable and retractable blade, the knife comprises: a handle comprising an internal space; a blade holding compartment pivotally connected to one end of the handle, the blade holding compartment having an opening, the opening situated on an opposing end of where the handle is pivotally attached to the blade holding compartment, at least a portion of the blade holding compartment is situated within at least a portion of the space of the handle during a folded storage position, the blade holding compartment is extended away from the handle during an extended usage position; a disposable blade disposed within at least a portion of the blade holding compartment, at least a portion of the blade protruding from the opening of the blade holding compartment during a first use position; and a means for retracting and extending the blade between the first use position and a second non-use position.

In another further embodiment, the present invention relates to a utility knife with a retractable blade, the knife comprises: a handle pivotally connected to a blade holding compartment, and the handle comprises at least two side walls forming a space, the space of the handle designed to encase at least a portion of a blade holding compartment during a folded position, the blade holding compartment comprising an internal cavity leading to an opening at a front end of the blade holding compartment which allows a portion of a blade to protrude from the blade holding compartment, a rear end of the blade holding compartment is pivotally attached to one end of the handle; and a device that allows the blade to be in a first extended position during use and then be retracted to a second non-use position, the entire blade is situated within the internal cavity of the blade holding compartment during the second position.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is a side view of the knife in a folded and blade retracted position;

FIG. 2 is a side view of FIG. 1 showing the blade holding compartment in an extended position and the blade in a retracted non-use position;

FIG. 3 is side view of FIG. 2 showing the blade in an extended use position;

FIG. 4 is a side view showing the storage cartridge; and

FIG. 5 is a perspective view showing the knife in an extended position and the blade in a retracted position.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION:

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

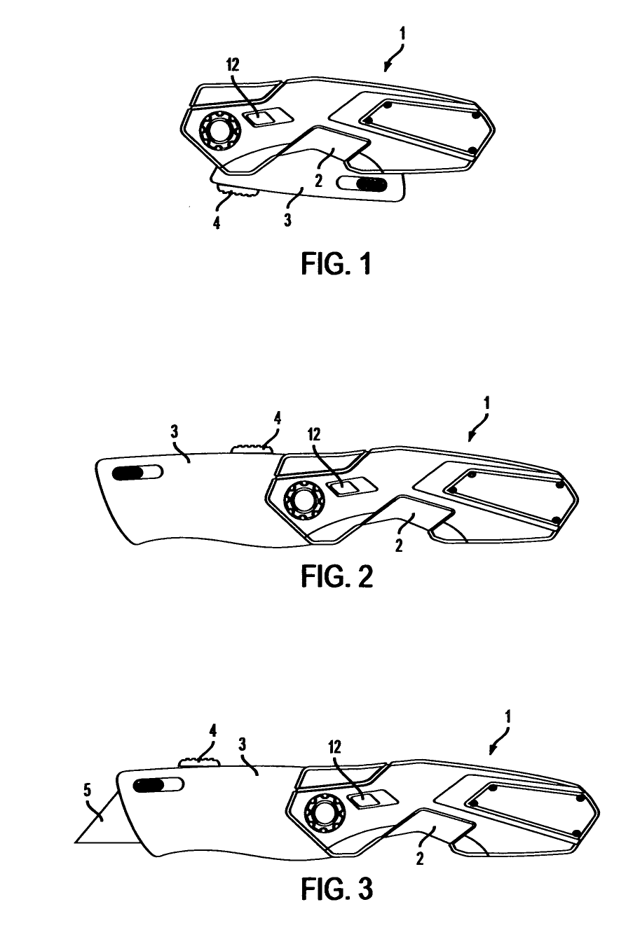

FIGS. 1-5 shows a folding utility knife 1 comprising: a handle 2 comprising an internal space; a blade holding compartment 3 pivotally connected to one end of the handle, the blade holding compartment 3 has an opening, and the opening 11 is situated on an opposing end of where the handle 2 is pivotally attached to the blade holding compartment 3; a disposable blade 5 disposed within at least a portion of the blade holding compartment 3, at least a portion of the blade 5 protrudes from the opening of the blade holding compartment 3 during a first use position; and a mechanism 4 for retracting and extending the blade between the first use position and a second non-use position. There is a device 12 for allowing the blade holding compartment to be folded and unfolded and locks the blade holding compartment 3 into place during a non-use position. By sliding the device 12, the blade holding compartment may be pulled away from the handle 2 during a use position (as shown in FIG. 1-2).

In FIG. 1, the blade holding compartment 3 is in a folded position and at least a portion of the compartment 3 is situated within the space of the handle 2. The mechanism 4 cannot move or move forward thus locking the blade 5 within the blade holding compartment 3.

FIG. 2 shows the blade 5 is a retracted position inside the blade holding compartment 3 and in another embodiment, the mechanism 4 is slid backwards to retract the blade 5.

FIG. 3 shows the blade 5 in an extended use position and in one embodiment, the mechanism 4 is slid forward to extend the blade 5. At least a portion of the blade and at least a portion of the sharp edge of the blade 5 extend from the opening 11 of the blade holding compartment 3.

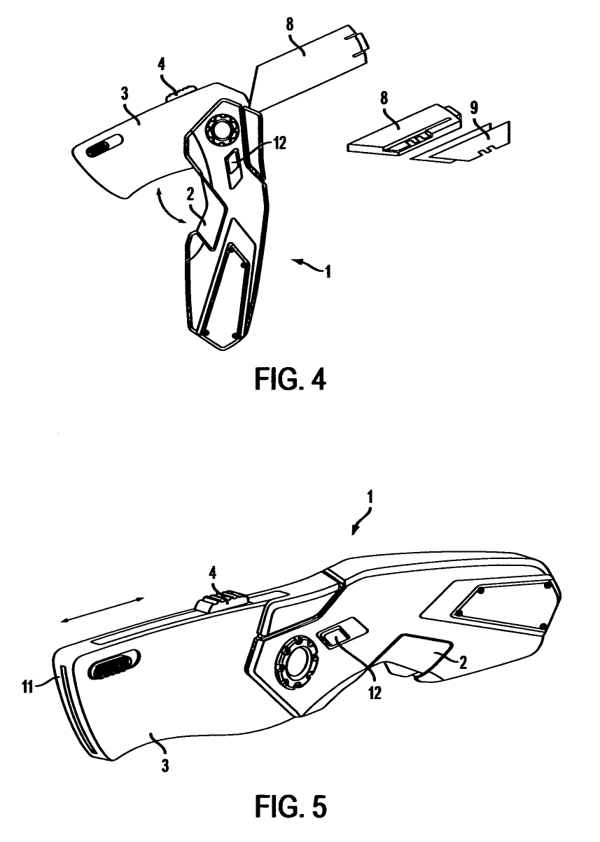

FIG. 4 shows the knife further comprises a storage cartridge 8 with a plurality of disposable blades 9. The cartridge 8 is stored within a portion of the blade storage compartment 3. The blade holding compartment 3 and the handle 2 must be positioned at an angle of generally 90 degrees or less to allow for access to the storage cartridge 8.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A folding utility knife comprising:
a handle comprising an internal space;
a blade holding compartment pivotally connected to one end of said handle, said blade holding compartment having an opening, at least a portion of said blade holding compartment is folded and situated within at least a portion of said space of said handle during a storage position, said blade holding compartment being extended away from said handle during an extended usage position;
a disposable blade disposed within at least a portion of said blade holding compartment;
a mechanism for extending said blade so that at least a portion of said blade protrudes from said opening of said blade holding compartment during a first position and retracting said blade completely within said blade holding compartment during a second position; and
a safety mechanism that prevent said blade from being extended until said blade holding compartment is fully extended during said usage position.

2. The knife of claim 1 wherein said blade has at least one side with a sharp edge for cutting, at least a portion of said blade being situated within said blade cavity of said blade holding compartment and a portion of the blade being situated outside of the blade holding compartment to expose at least a portion of the sharp edge of said blade.

3. The knife of claim 1 further comprising an external device for controlling the mechanism which extends and retracts said blade.

4. The knife of claim 1 wherein said mechanism comprises a track device which allows said blade to slideably move within said blade holding compartment.

5. The knife of claim 1 further comprising a device for controlling the folding and extending of said blade holding compartment.

6. The knife of claim 5 wherein said device that controls the folding and extending of said blade holding compartment comprises a locking mechanism that locks said blade holding compartment in said extended usage position.

7. The knife of claim 6 wherein said locking mechanism locks said blade holding compartment in said folded storage position.

8. The knife of claim 1 further comprises a storage cartridge with a plurality of disposable blades.

9. The knife of claim 8 wherein said cartridge is stored within a portion of said blade storage compartment.

10. The knife of claim 8 wherein said cartridge is stored within a portion of said handle.

11. The knife of claim 9 wherein said blade holding compartment and said handle must be positioned at an angle of generally 90 degrees or less to allow for access to said storage cartridge.

12. The knife of claim 6 wherein said locking mechanism comprises a release button.

13. A folding utility knife comprising:
a handle comprising an internal space;
a blade holding compartment pivotally connected to one end of said handle, said blade holding compartment having an opening, said opening situated on an opposing end of where said handle is pivotally attached to said blade holding compartment, at least a portion of said blade holding compartment is situated within at least a portion of said space of said handle during a folded storage position, said blade holding compartment being extended away from said handle during an extended usage position;
a disposable blade disposed within at least a portion of said blade holding compartment, at least a portion of said blade protruding from said opening of said blade holding compartment during a first use position; and
a means for retracting and extending said blade between said first use position and a second non-use position.

14. The knife of claim 13 further comprising a means for preventing said blade from being extended until said blade holding compartment is fully extended during said first use position.

15. The knife of claim 13 further comprising a blade storage cartridge.

16. A folding utility knife comprising:
a handle pivotally connected to a blade holding compartment, said handle comprising at least two side walls forming a space, said space of said handle designed to encase at least a portion of a blade holding compartment during a folded position, said blade holding compartment comprising an internal cavity leading to an opening at a front end of said blade holding compartment which allows a portion of a blade to protrude from said blade holding compartment, a rear end of said blade holding compartment is pivotally attached to one end of said handle; and
a device that allows said blade to be in a first extended position during use and then be retracted to a second non-use position, said entire blade is situated within said internal cavity of said blade holding compartment during said second position.

17. The knife of claim 16 further comprising a mechanism which prevents said blade from being in an extended position unless said blade holding compartment is fully extended away from said handle during said use position.

18. The knife of claim 17 wherein said mechanism is a locking mechanism.

19. The knife of claim 18 wherein said mechanism is a safety mechanism.

20. The knife of claim 18 further comprising a blade storage compartment.
